(19) United States
(12) Patent Application Publication
(10) Pub. No.: US 2026/0180632 A1
(43) Pub. Date: Jun. 25, 2026

(54) REFINING PHASE COHERENCE IN UPLINK MIMO

(71) Applicant: QUALCOMM Incorporated, San Diego, CA (US)

(72) Inventors: Yi HUANG, San Diego, CA (US); Yu ZHANG, San Diego, CA (US); Jing JIANG, San Diego, CA (US); Timo Ville VINTOLA, San Diego, CA (US)

(21) Appl. No.: 18/989,988

(22) Filed: Dec. 20, 2024

(51) Int. Cl. H04B 7/0456; H04L 5/00

(52) U.S. Cl. CPC H04B 7/0456; H04L 5/0048

(57) ABSTRACT

Certain aspects of the present disclosure provide techniques for sending capability information associated with a plurality of antennas of the user equipment (UE), the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent; and communicating using the first antenna group and the second antenna group in accordance with the capability information.

### INTRODUCTION

### Field of the Disclosure

Aspects of the present disclosure relate to wireless communications, and more particularly, to techniques for refining phase coherence in uplink MIMO transmission.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communication by a user equipment (UE). The method includes sending capability information associated with a plurality of antennas of the UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent; and communicating using the first antenna group and the second antenna group in accordance with the capability information.

Certain aspects provide a method for wireless communications by a network entity. The method includes receiving capability information associated with a plurality of antennas of a UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent; indicating a precoder from a multiple-input, multiple-output (MIMO) codebook based on the field; and communicating in accordance with the indicated precoder.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIG. 6 illustrates a matrix notation of an example precoding feedback codebook.

FIG. 7 is diagram illustrating examples of full coherence, partial coherence, and noncoherence across antenna groups of a plurality of antenna groups

FIG. 8 is a diagram illustrating examples of precoders.

FIG. 9 is a diagram illustrating examples of mild coherence

FIG. 10 is a diagram illustrating an example of signaling for indication of capability information and a precoder for a UE that implements mild coherence.

FIG. 11 depicts a process flow for communications in a system between a network entity and a UE.

FIG. 12 is a diagram illustrating an example of a field of capability information that indicates a set of coherent antenna groups.

FIG. 13 depicts a method for wireless communications.

FIG. 14 depicts another method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for refining phase coherence in uplink MIMO transmission.

Wireless communication networks prioritize data transfer speed and reliability and Multi-Input Multi-Output (MIMO) is a technology frequently used to improve the speed and quality of wireless data transfers. MIMO works by sending and receiving different data using multiple antennas, thus increasing the number of antennas in the data transfer path. Examples of MIMO systems include 2×2 MIMO, which uses two sending (Tx) and two receiving (Rx) antennas, or 4×4 MIMO, where four Tx and four Rx antennas are used. MIMO is currently used by many wireless standards as the mainstream technology for uplink and downlink connections between the base stations and transmitters, as well as between terminals and receivers.

In MIMO, multiple streams of data, known as “MIMO layers,” are created and mapped to individual antennas. Thus, the maximum number of MIMO layers is equal to the number of available antennas. Then, parallel processing is performed on the MIMO layers, where the same parallel processing is used at both the transmitter and receiver so that the signals received at each antenna of the receiver can be separated from one another. Each of the parallel-processed data streams is sent from the corresponding antenna, and a respective receive antenna receives the mixed signals from each of the transmit antennas. The receiver performs reverse parallel processing to the parallel processing used at the transmitter to separate the mixed signals and recreate the MIMO layers.

In general MIMO technology, the carrier frequency of the RF signal used between each channel is the same as the bandwidth and the phase and timing at sending are also synchronized. However, due to channel conditions, e.g., the distance between antennas in the wireless area and the presence of interfering objects, such as buildings, the signals may be attenuated and delayed, causing frequency and amplitude/phase errors at the receiver antennas. The receiver corrects these errors using techniques such as equalizing to recover the original data.

When the phase and timing between RF signals are synchronized, there is a fixed phase difference, or offset, between the RF signals. This is called the phase coherence, and may be defined in the wireless network as follows: if the phase difference of the uplink sounding reference signals (SRS) sent from two transmitting antennas and the phase difference of the physical uplink shared channel (PUSCH) signal sent from the same two transmitting antennas are within 40 degrees of each other, the two transmitting antennas are coherent. If the two transmitting antennas are coherent, phase coherence is guaranteed between the two transmitting antennas. Similarly, the transmitting antennas are noncoherent if the difference is greater than 40 degrees.

In certain aspects of uplink MIMO transmission, codebook-based precoding may be used to map data streams, or MIMO layers, to specific antennas or antenna groups. The codebook may comprise a set of precoding weights expressed as a list of matrices, where the dimension of each matrix is defined by the number of available MIMO layers and the number of antennas, where the number of MIMO layers cannot exceed the number of antennas at the UE. As an example, a 4×4 matrix may support four (4) antennas available for transmission and four MIMO layers to be mapped to the antennas. As a result of the need to account for the many possible combinations of MIMO layers and available UE antennas, multiple codebooks may be defined in standards for the wireless network.

Within each codebook, the precoder weights are arranged to account for three different types of coherence that are signaled in current production MIMO systems for the antennas, e.g., using the MIMO-ParametersPerBand parameter structure. In full coherence, phase coherence can be maintained between any two of the antennas, while in non-coherence, none of the antennas can maintain phase coherence with one another. The third defined type is partial coherence, where the antennas can be grouped into antenna groups and phase coherence is maintained between the antennas of any one of the antenna antenna groups but there is no phase coherence across antenna groups. In an example, consider that four antennas are grouped such that a first antenna group comprises antennas one and three and a second antenna group comprises antennas two and four. For full coherence, all four antennas would maintain phase coherence and in non-coherence, no phase coherence would be maintained among the four antennas. For partial coherence, antennas one and three would maintain phase coherence with each other and antennas two and four would maintain phase coherence with each other but the two groups do not maintain phase coherence with each other (e.g. antenna one would not maintain phase coherence with antenna two).

The cost of maintaining phase coherence within each antenna group may be non-trivial in the manufacture of UE equipment as the number of transmitting antennas implemented at a UE increases. Because support only currently exists for partial coherence, the addition of a pair of transmitting antennas, or a new antenna group, to a UE that already implements a group of two coherent antennas would require the two new antennas to be in phase coherence with each other, even if the new antennas are not in phase coherence with the existing antennas.

Aspects described herein may overcome this technical problem by defining a fourth type of coherence known as mild coherence. A UE that implements mild coherence may have one or more coherent antenna groups and one or more non-coherent antenna groups. Continuing the example above, the first and second antenna groups would not maintain phase coherence with each other (as in partial coherence). However, mild coherence would allow for phase noncoherence between the antennas within either one of the first or second antenna groups, that is, antennas one and three or antennas two and four. It should be noted that if both antenna groups do not maintain phase coherence between antennas in the antenna group, this is already defined as noncoherence.

Aspects described herein relate to techniques for providing UE capabilities signaling for indicating the phase coherence of individual transmitting antenna antenna groups in the UE. Also described herein is a corresponding expansion of the MIMO precoder codebook to account for mild coherence, or the case where one or more antenna antenna groups do not maintain phase coherence within the antenna group. For example, a UE may send, and a network entity may receive, capability information that includes a field comprising a plurality of bit positions. The bit positions may be associated with antenna groups known to the UE. For example, in 2×2 MIMO, the field may comprise two bits, one for each antenna group. The values of the bits may be set to indicate whether phase coherence is maintained within the antenna group, e.g., antennas one and three in the example are coherent so the value of the bit position corresponding to the first antenna group is one and the second bit position would have a value of zero since antennas two and four do not maintain phase coherence.

The network entity that receives the UE capabilities information may parse the field to determine the specific antenna groups of the UE that maintain phase coherence. Based on the values of the bit positions in the field, the network entity selects a MIMO precoder from the codebook to use for transmission in the network. As mentioned above, an expanded codebook is described herein that includes precoder weights, e.g., matrices as described above, arranged appropriately to account for mild coherence. The network entity may send an indication to the UE, e.g., a Transmitter Precoding Matrix Indicator (TPMI), so that the UE may map its MIMO layers to the correct antenna group for transmission.

Certain techniques for providing UE capabilities signaling between network nodes may have the technical benefit of efficiently notifying a network entity of the presence of mild coherence, or that some antenna antenna groups do not maintain phase coherence. As a result, the network entity may quickly select a new MIMO precoder from the codebook to ensure that wireless data transfer is completed in the most efficient and reliable manner possible.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

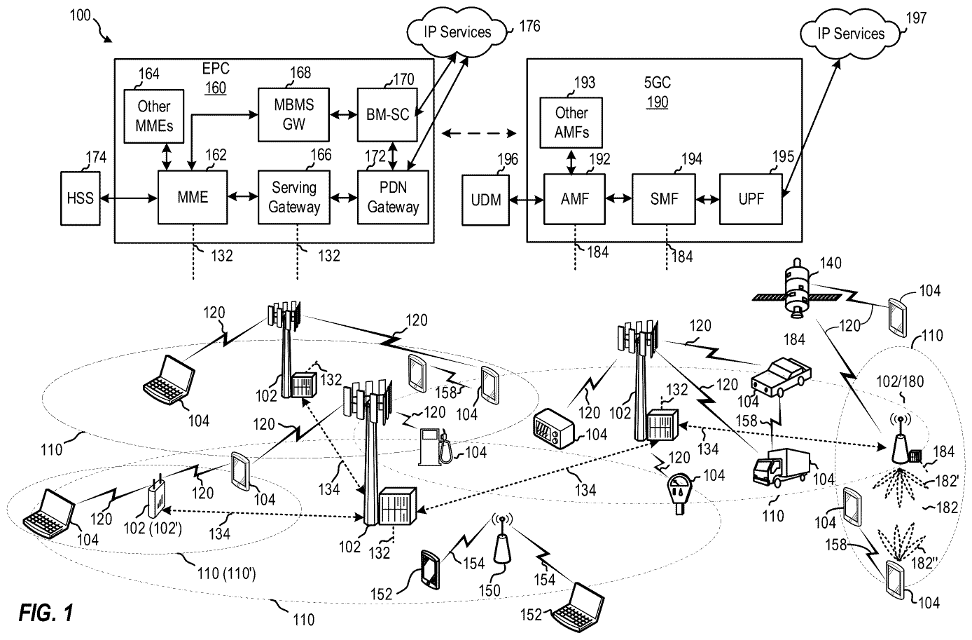

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

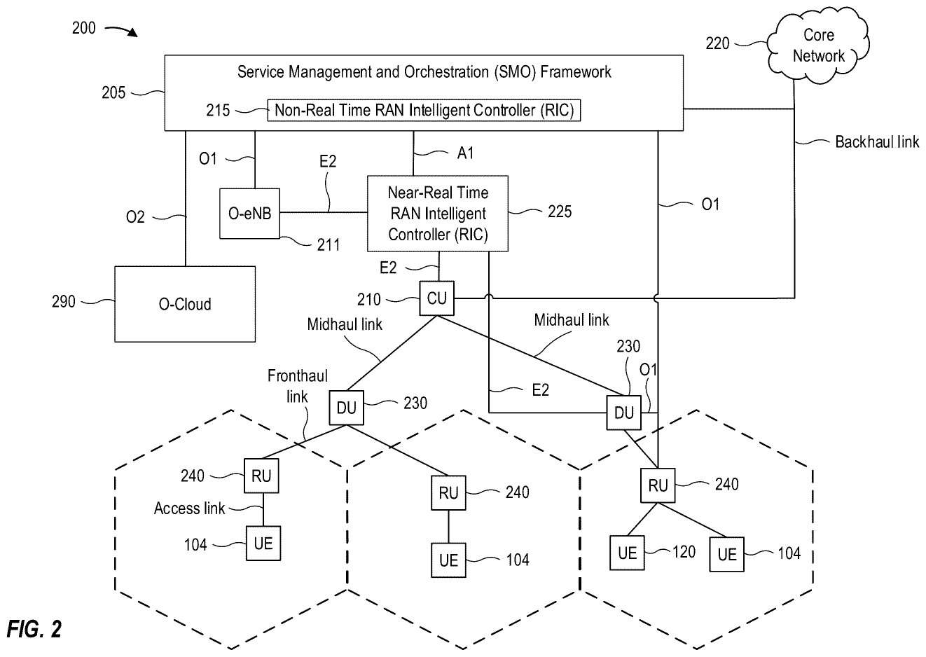

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

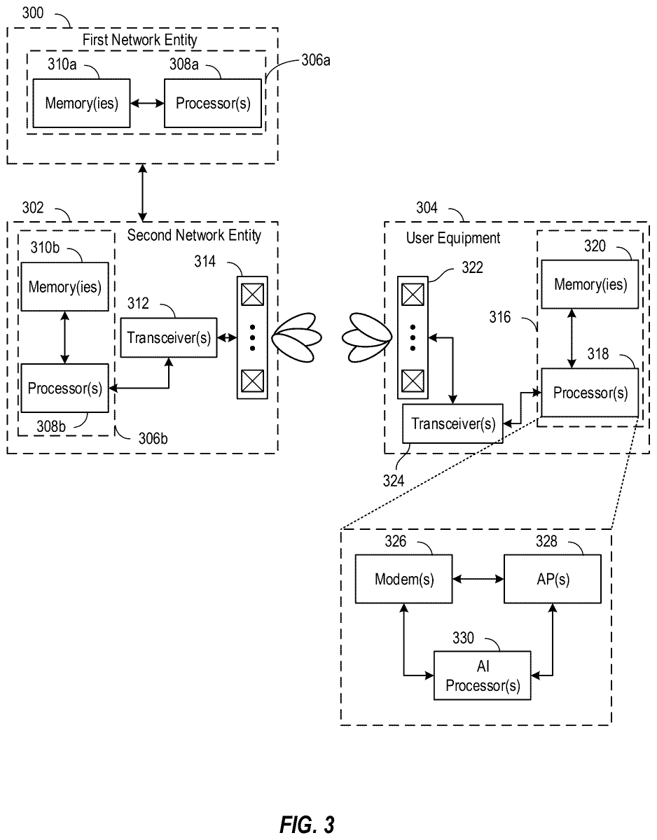

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

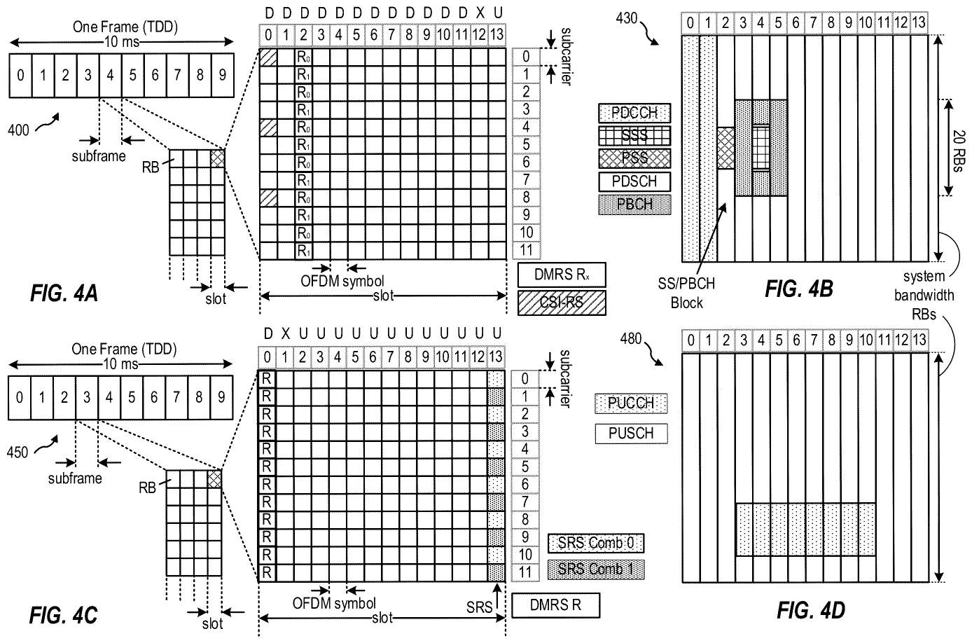

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS), sometimes referred to as uplink SRS. The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communication systems, closed-loop feedback associated with a communication channel may be used to dynamically adapt communication parameters to channel conditions that may change over time. In some cases, a UE may receive a reference signal (e.g., SSB, CSI-RS, DM-RS, etc.) from a network entity (or another UE) and report channel state feedback to the network entity (or the other UE), where the channel state feedback is determined based on measurements of the reference signal received at the UE. In certain cases, a UE may transmit a reference signal (e.g., SSB, CSI-RS, DM-RS, PT-RS, SRS, etc.), and a network entity (or another UE) may determine characteristics associated with the channel based on measurements of the received reference signal.

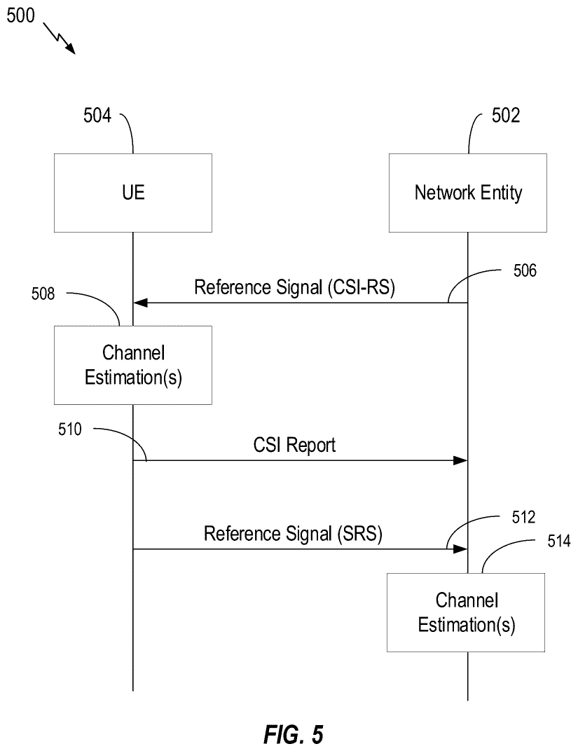

FIG. 5 depicts a process flow 500 for closed-loop feedback associated with a communication channel between a network entity 502 and a UE 504.

At 506, the UE 504 receives a reference signal (e.g., SSB, CSI-RS, etc.) from the network entity 502.

At 508, the UE 504 performs channel calculations based on the reference signal, such as determining a channel estimate H based on the received reference signal. For example, the UE 504 may include a demodulator, which may be part of a transceiver, RX MIMO detector, and/or receive processor of UE 504. The demodulator, such as a component of the demodulator, may take as input the reference signal as received over multiple antennas of the UE 504 and output a vector y that is a representation of the received reference signal as received over each of the multiple antennas of the UE 504.

Based on a received signal model, the vector y can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communication channel where the reference signal is communicated), x is the vector representing symbols transmitted by network entity 502 over a number of spatial layers, and n′ is noise across the communications channel. In certain aspects, H has a size equal to the number of antennas used to receive the signaling, Nant, times the number of spatial layers, Ni, (e.g., the number of beamformed transmissions, number of antenna ports, etc.). For example, H has a number of rows equal to Nant and a number of columns equal to Ni. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 510, UE 504 sends to network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for the downlink transmissions on the PDSCH. CQI may be an indicator of channel quality, such as corresponding to H. The UE 504 may send an indication of the one or more determined CSI parameters to the network entity 502 in the CSI report. The network entity 502 may schedule downlink data transmissions to the UE 504 accordingly, such as using a modulation scheme, code rate, number of transmission layers, etc., that the network entity determines based on the CSI report.

At 512, UE 504 sends a reference signal (e.g., SSB, CSI-RS, DM-RS, PT-RS, SRS, etc.) to the network entity 502.

At 514, the network entity 502 performs channel calculations based on the reference signal, such as determining a channel estimate H based on the received reference signal, for example, as described herein with respect to the UE performing channel calculations at 508.

In certain aspects, network entity 502 may further calculate, as part of the channel calculations, a precoder (e.g., precoder matrix) V based on the channel estimate H, for example, as described herein with respect to the UE 504 performing such a calculation. Accordingly, the network entity 502 may determine H and/or V for an uplink channel between UE 604 and network entity 502 based on SRS. Further, as discussed, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

### Aspects Related to Precoding Feedback

In certain aspects, precoding feedback described herein may be indicated via a precoding codebook. A precoding codebook may define the matrix notation for reporting the preferred precoding for one or more beams, for example, in the context of gains and phase shifts applied across antenna elements that form certain beams. Certain wireless communication systems (e.g., 5G NR or any future wireless communication system) may define the precoding codebooks used for precoding feedback. As an example, 5G NR systems may use Type-I codebooks, Type-II codebooks, and Type-II port selection codebooks.

The Type-I codebooks are primarily used for single-user MIMO (SU-MIMO) with support for high and low order MIMO transmissions (e.g., 8×8, 4×4, and 2×2 MIMO). The Type-I codebooks may be used in line-of-sight scenarios for the communication link between the UE and the network entity. The Type-I codebooks may include single panel and multi-panel codebooks, where single panel and multi-panel refer to the transmission panel(s) used at the network entity.

The Type-II codebooks are used for multi-user MIMO (MU-MIMO) with support for up to two MIMO layers. The Type-II codebooks may provide more accurate channel state information with respect to the Type-I codebooks. The Type-II codebooks may include a Type-II codebook, an Enhanced Type-II codebook, a Type-II Doppler codebook, and a Type-II coherent joint transmission (CJT) codebook.

The Type-II port selection codebooks are used for obtaining refined precoding feedback with respect to the Type-I and Type-II codebooks. The Type-II port selection codebooks rely on reference signals that have been beamformed at the network entity, for example, where the network entity has some knowledge of the communication channel between the UE and the network entity (e.g., knowledge derived from one of the other precoding codebooks, such as the Type-I and Type-II codebooks). The Type-II port selection codebooks may include a Type-II port selection codebook, an Enhanced Type-II Port Selection codebook, and a Further Enhanced Type-II Port Selection codebook. The Type-II codebooks and the Type-II port selection codebooks may be used in multi-path channels. The Enhanced Type-II Port Selection codebook and the Further Enhanced Type-II Port Selection codebook may be used for spatial and frequency sparsity.

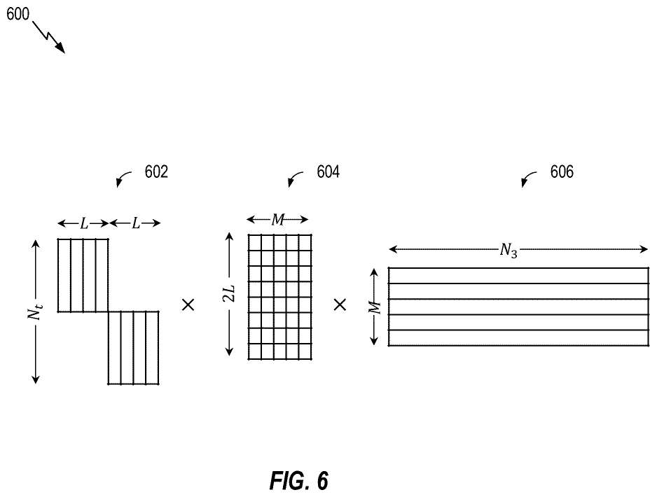

FIG. 6 illustrates a matrix notation 600 of an example precoding feedback codebook, for example, an Enhanced Type-II codebook. The Enhanced Type-II codebook supports up to rank 4 precoding feedback with reduced overhead using a compression technique. In this example, a precoder matrix [symbol] for a particular layer ( [symbol] ) may be given by the following expression:

$${W}^{( ℓ )} = {W}_{1} {W}_{2 , ℓ} {W}_{f , ℓ}^{H}$$

where W₁ is a wideband spatial domain (SD) basis (e.g., a beam matrix 602); [symbol] is a coefficient matrix 604 comprising subband phases and subband amplitudes; and [symbol] is a delay matrix 606 (e.g., a frequency domain (FD) basis) comprising delay information that maps phase information of the N₃ subbands to the M basis vectors. The precoder matrix [symbol] has a size of Nₜ×N₃, where Nₜ is the number of transmit antenna elements (which may include physical or logical antenna elements), N₃ is the number of subbands being reported and determined by a number of CQI subbands and the number of PMI subbands per CQI subband.

The beam matrix 602 (W₁) is a block-diagonal matrix having a size of Nₜ×2L and may be the same for all layers (e.g., layer common), where L is the number of beams being reported and may be configured via control signaling. The coefficient matrix 604 ( [symbol] ) has a size of 2L×M and is specific to each layer (e.g., layer specific), where M is the number of basis vectors in the frequency domain. M may be configured via control signaling and based on the rank indicator (RI). The UE may be configured with a parameter (K₀) that defines the maximum number of non-zero coefficients that can be reported across all layers. The delay matrix 606 ( [symbol] ) has a size of M×N₃ and is specific to each layer (e.g., layer specific).

One difference between port selection codebooks and non-port selection codebooks (e.g., Type-I codebooks and Type-II codebooks) is in the SD basis selection mechanisms. In the non-port selection codebooks, the UE indicates SD bases via CSI feedback, for example, as part of the beam matrix W₁. For example, the UE generates intermediate candidate beams using spatial oversampling between spatially separated orthogonal beams, and the UE may select one or several strong beams among the candidate beams based on the CSI. In port selection codebooks, the network entity transmits precoded reference signals with different precoders, where each precoder represents a particular beam and is associated with an antenna port. The UE selects several antenna ports by measurements of the corresponding reference signals and reports the coefficients. Thus, the beams are determined by antenna port selection. In FR2, the UE may indicate spatial beams during certain beam management operations, and codebooks may generally be thought of as port selection codebooks. Port selection codebooks may provide lower complexity and improved scaling for UE antenna array sizes.

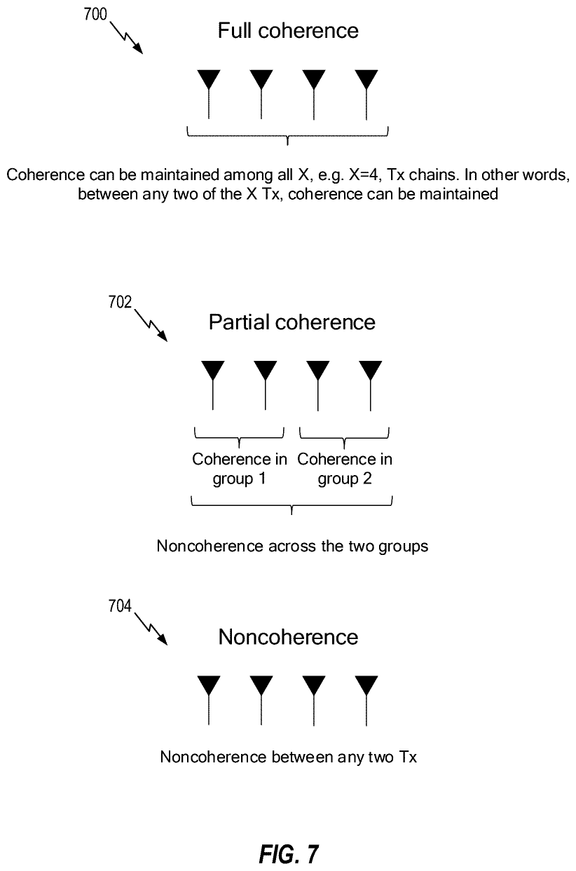

FIG. 7 is diagram illustrating examples of full coherence, partial coherence, and noncoherence across antenna groups of a plurality of antenna groups. Each of examples 700, 702, and 704 include 4 antennas. Each antenna may correspond to (e.g., be implemented as part of) a separate transmit chain. Example 700 illustrates full coherence. In example 700, coherence can be maintained across all four transmit chains. Thus, between any two antennas of the four antennas, coherence can be maintained. Thus, a layer of a MIMO communication can be mapped to any combination of the four antennas of example 700.

In example 702, coherence is maintained within a first antenna group of the plurality of antenna groups (denoted “antenna group 1”). Thus, a layer of a MIMO communication can be mapped to the antennas (transmit chains) of the first antenna group. Furthermore, coherence is maintained within a second antenna group of the plurality of antenna groups (denoted “antenna group 2”). Thus, a layer of a MIMO communication can be mapped to the antennas (transmit chains) of the second antenna group. A layer of a MIMO communication cannot be simultaneously mapped to both antenna groups, or to an antenna of the first antenna group and an antenna of the second antenna group.

In example 704, all of the antennas are noncoherent with one another. Thus, a layer of a MIMO communication can be mapped to only a single antenna at a time.

If a layer of a MIMO communication is mapped to an antenna, the antenna is used to transmit the MIMO communication.

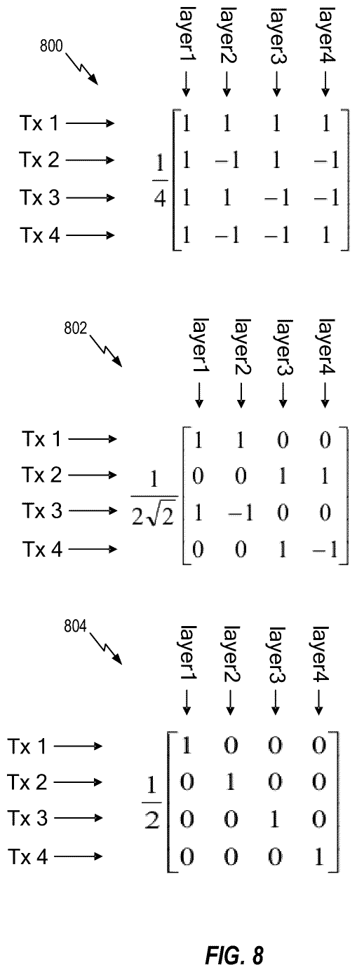

FIG. 8 is a diagram illustrating examples 800, 802, and 804 of precoders. Example 800 shows a precoder for a set of antennas with full coherence, as in example 700. Example 802 shows a precoder for two antenna groups, including a first coherent antenna group and a second coherent antenna group, as in example 702. Example 804 shows a precoder for a plurality of noncoherent antennas, as in example 704.

The precoders of FIG. 8 are represented as matrixes. Each column of a precoder corresponds to a layer of a MIMO communication. Each row of a precoder corresponds to an antenna and/or transmit chain (denoted “Tx 1” and so on). Thus, the precoders of FIG. 8 are examples of 4×4 precoders for 4-layer MIMO communication via 4 antennas.

In the precoder of example 800, the four antennas are fully coherent with one another. Thus, a given layer (for example, layer 1, in the leftmost column) can be mapped to (e.g., transmitted using) up to all of the four antennas, as indicated by the coefficients in each row of the first column. In the precoder of example 802, Tx 1 and Tx 3 belong to a first antenna group that is coherent, and Tx 2 and Tx 4 belong to a second antenna group that is coherent. In example 802, a first layer and a second layer (layer 1 and layer 2) are mapped to the first antenna group (where the first layer and the second layer are each transmitted on both Tx 1 and Tx 3), and a third layer and a fourth layer (layer 3 and layer 4) are mapped to the second antenna group (where the third layer and the fourth layer are each transmitted on both Tx 2 and Tx 4). In the precoder of example 804, each layer can be mapped to only a single antenna, since the plurality of antennas is non-coherent. Thus, layer 1 is mapped to Tx 1, layer 2 is mapped to Tx 2, layer 3 is mapped to Tx 3, and layer 4 is mapped to Tx 4.

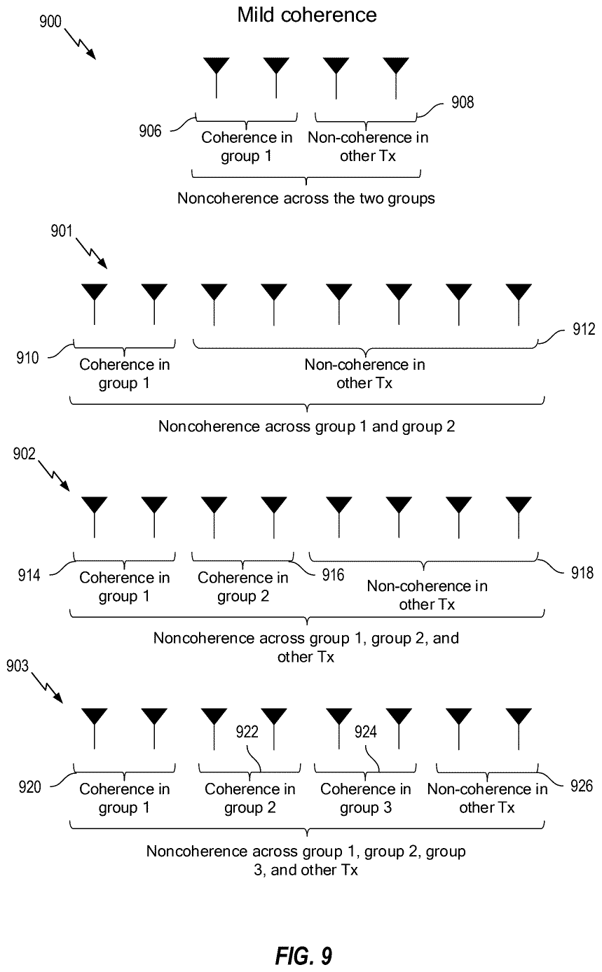

FIG. 9 is a diagram illustrating examples 900, 901, 902, and 903 of mild coherence. As described above, mild coherence provides for a first antenna group of a plurality of antennas of a UE to be coherent, and for other antennas of the plurality of antennas to be noncoherent. Mild coherence simplifies implementation of additional antennas at a UE, thereby supporting higher numbers of MIMO layers without unduly increasing the complexity of the UE.

Example 900 is an example for a UE with four antennas. As shown, a first antenna group 906 (illustrated as “antenna group 1”) is coherent. Thus, one or two layers of a MIMO communication can be mapped to the first antenna group 906. Remaining antennas 908 (illustrated as “other Tx” and including two antennas in example 900) are not coherent with one another. Thus, a respective layer can be mapped to each of the remaining antennas 908 (e.g., one layer per antenna). In some aspects, the remaining antennas 908 may not be coherent with any of the antennas of the first antenna group 906.

Example 901 is a first example for a UE with eight antennas. As shown, a first antenna group 910 (illustrated as “antenna group 1”) is coherent. Thus, one or two layers of a MIMO communication can be mapped to the first antenna group 910. Remaining antennas 912 (illustrated as “other Tx” and including six antennas in example 901) are not coherent with one another. Thus, a respective layer can be mapped to each of the remaining antennas 912 (e.g., one layer per antenna). In some aspects, the remaining antennas 912 may not be coherent with any of the antennas of the first antenna group 910.

Example 902 is a second example for a UE with eight antennas. As shown, a first antenna group 914 (illustrated as “antenna group 1”) is coherent. Thus, one or two layers of a MIMO communication can be mapped to the first antenna group 914. As shown, a second antenna group 916 (illustrated as “antenna group 2”) is coherent. Thus, one or two layers of a MIMO communication can be mapped to the second antenna group 916. Remaining antennas 918 (illustrated as “other Tx” and including four antennas in example 902) are not coherent with one another. Thus, a respective layer can be mapped to each of the remaining antennas 918 (e.g., one layer per antenna). In some aspects, the remaining antennas 918 may not be coherent with any of the antennas of the first antenna group 914 or the second antenna group 916. Further, antennas of the first antenna group 914 may not be coherent with antennas of the second antenna group 916.

Example 903 is a third example for a UE with eight antennas. As shown, a first antenna group 920 (illustrated as “antenna group 1”) is coherent. Thus, one or two layers of a MIMO communication can be mapped to the first antenna group 920. As shown, a second antenna group 922 (illustrated as “antenna group 2”) is coherent. Thus, one or two layers of a MIMO communication can be mapped to the second antenna group 922. As shown, a third antenna group 924 (illustrated as “antenna group 3”) is coherent. Thus, one or two layers of a MIMO communication can be mapped to the third antenna group 924. Remaining antennas 926 (illustrated as “other Tx” and including two antennas in example 903) are not coherent with one another. Thus, a respective layer can be mapped to each of the remaining antennas 926 (e.g., one layer per antenna). In some aspects, the remaining antennas 926 may not be coherent with any of the antennas of the first antenna group 920, the second antenna group 922, or the third antenna group 924. Further, antennas of the first antenna group 920 may not be coherent with antennas of the second antenna group 922 or the third antenna group 924, antennas of the second antenna group 922 may not be coherent with antennas of the first antenna group 920 or the third antenna group 924, and antennas of the third antenna group 924 may not be coherent with antennas of the second antenna group 922 or the first antenna group 920.

A UE may transmit a communication on a plurality of antennas, in a mild coherence configuration shown in examples 900, 901, 902, and/or 903, using a precoder. A precoder for a UE that implements mild coherence may be based on a combination of a coherent precoder (e.g., one or more coherent precoders) and a non-coherent precoder. For example, a precoder for mild coherence may include a diagonal concatenation of a coherent precoder and a non-coherent precoder. As an example of diagonal concatenation, a first matrix of

$$[ \begin{matrix}1 & 1 \\ 1 & 1\end{matrix} ] ,$$

diagonally concatenated with a second matrix of

$$[ \begin{matrix}2 & 2 \\ 2 & 2\end{matrix} ] ,$$

produces a third matrix of

$$[ \begin{matrix}1 & 1 & 0 & 0 \\ 1 & 1 & 0 & 0 \\ 0 & 0 & 2 & 2 \\ 0 & 0 & 2 & 2\end{matrix} ] .$$

For example, a number of rows of the first matrix and a number of rows of the second matrix may be summed to determine a number of rows of the third matrix. A number of columns of the first matrix and a number of columns of the second matrix may be summed to determine a number of columns of the third matrix. The first matrix may be placed in the third matrix starting at a first row and first column. The second matrix may be placed in the third matrix starting at a next row and a next column after a last row and column of the first matrix. Remaining values may be set to zero. In the context of precoders for mild coherence, a coherent precoder may be implemented as the first matrix of the diagonal concatenation (and referred to herein as a first portion of the third matrix or the precoder) and a non-coherent precoder may be implemented as the second matrix of the digital concatenation (and referred to herein as a second portion of the third matrix or the precoder). More than two matrixes can also be diagonally concatenated as described above.

Examples of precoders for a UE that implements 4 antennas with a first antenna group that is coherent and remaining antennas that are non-coherent (as in example 900) are provided now. It should be noted that, in some examples, certain rows of these precoders may be arranged differently than what is shown here according to how antenna ports of the UE are indexed. For example, for 4 layers, a second row and a third row of an example precoder may be switched with one another according to antenna port indexing of the example precoder.

For 4 layers, a first example precoder is

$$[ \begin{matrix}1 / 2 \sqrt{2} & 1 / 2 \sqrt{2} & 0 & 0 \\ 1 / 2 \sqrt{2} & - 1 / 2 \sqrt{2} & 0 & 0 \\ 0 & 0 & 1 / 2 & 0 \\ 0 & 0 & 0 & 1 / 2\end{matrix} ] .$$

For 4 layers, a second example precoder is

$$[ \begin{matrix}1 / 2 \sqrt{2} & 1 / 2 \sqrt{2} & 0 & 0 \\ j / 2 \sqrt{2} & - j / 2 \sqrt{2} & 0 & 0 \\ 0 & 0 & 1 / 2 & 0 \\ 0 & 0 & 0 & 1 / 2\end{matrix} ] .$$

For 3 layers, a first example precoder is

$$[ \begin{matrix}1 / \sqrt{6} & 1 / \sqrt{6} & 0 \\ 1 / \sqrt{6} & - 1 / \sqrt{6} & 0 \\ 0 & 0 & 1 / \sqrt{3} \\ 0 & 0 & 0\end{matrix} ] .$$

For 3 layers, another example precoder is

$$[ \begin{matrix}1 / \sqrt{6} & 1 / \sqrt{6} & 0 \\ 1 / \sqrt{6} & - 1 / \sqrt{6} & 0 \\ 0 & 0 & 0 \\ 0 & 0 & 1 / \sqrt{3}\end{matrix} ] .$$

For 3 layers, another example precoder is

$$[ \begin{matrix}1 / \sqrt{6} & 1 / \sqrt{6} & 0 \\ j / \sqrt{6} & - j / \sqrt{6} & 0 \\ 0 & 0 & 1 / \sqrt{3} \\ 0 & 0 & 0\end{matrix} ] .$$

For 3 layers, another example precoder is

$$[ \begin{matrix}1 / \sqrt{6} & 1 / \sqrt{6} & 0 \\ j / \sqrt{6} & - j / \sqrt{6} & 0 \\ 0 & 0 & 0 \\ 0 & 0 & 1 / \sqrt{3}\end{matrix} ] .$$

For 3 layers, another example precoder is

$$[ \begin{matrix}1 / 2 & 0 & 0 \\ 1 / 2 & 0 & 0 \\ 0 & 1 / 2 & 0 \\ 0 & 0 & 1 / 2\end{matrix} ] .$$

For 3 layers, another example precoder is

$$[ \begin{matrix}1 / 2 & 0 & 0 \\ - \frac{1}{2} & 0 & 0 \\ 0 & \frac{1}{2} & 0 \\ 0 & 0 & \frac{1}{2}\end{matrix} ] .$$

For 3 layers, another example precoder is

$$[ \begin{matrix}1 / 2 & 0 & 0 \\ j / 2 & 0 & 0 \\ 0 & 1 / 2 & 0 \\ 0 & 0 & 1 / 2\end{matrix} ] .$$

For 3 layers, another example precoder is

$$[ \begin{matrix}1 / 2 & 0 & 0 \\ - j / 2 & 0 & 0 \\ 0 & 1 / 2 & 0 \\ 0 & 0 & 1 / 2\end{matrix} ] .$$

For 2 layers, another example precoder is

$$[ \begin{matrix}1 / 2 & 1 / 2 \\ 1 / 2 & - 1 / 2 \\ 0 & 0 \\ 0 & 0\end{matrix} ] .$$

For 2 layers, another example precoder is

$$[ \begin{matrix}1 / 2 & 1 / 2 \\ j / 2 & - j / 2 \\ 0 & 0 \\ 0 & 0\end{matrix} ] .$$

For 2 layers, another example precoder is

$$[ \begin{matrix}0 & 0 \\ 0 & 0 \\ 1 & 0 \\ 0 & 1\end{matrix} ] .$$

For 2 layers, another example precoder is

$$[ \begin{matrix}1 / \sqrt{3} & 0 \\ 1 / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ - 1 / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ j / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ - j / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ 1 / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ - 1 / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ j / \sqrt{3} & 0 \\ 0 & 1 / \sqrt{3} \\ 0 & 0\end{matrix} ] .$$

For 2 layers, another example precoder is

$$[ \begin{matrix}1 / \sqrt{3} & 0 \\ - j / \sqrt{3} & 0 \\ 0 & 1 / \sqrt{3} \\ 0 & 0\end{matrix} ] .$$

For 1 layer, an example precoder is

$$[ \begin{matrix}1 / \sqrt{2} \\ 1 / \sqrt{2} \\ 0 \\ 0\end{matrix} ] .$$

For 1 layer, another example precoder is

$$[ \begin{matrix}1 / \sqrt{2} \\ - 1 / \sqrt{2} \\ 0 \\ 0\end{matrix} ] .$$

For 1 layer, another example precoder is

$$[ \begin{matrix}1 / \sqrt{2} \\ j / \sqrt{2} \\ 0 \\ 0\end{matrix} ] .$$

For 1 layer, another example precoder is

$$[ \begin{matrix}1 / \sqrt{2} \\ - j / \sqrt{2} \\ 0 \\ 0\end{matrix} ] .$$

For 1 layer, another example precoder is

$$[ \begin{matrix}0 \\ 0 \\ 1 \\ 0\end{matrix} ] .$$

For 1 layer, another example precoder is

$$[ \begin{matrix}0 \\ 0 \\ 0 \\ 1\end{matrix} ] .$$

Aspects described herein provide signaling of a UE capability, configuration, or support for one or more mild coherence configurations (such as one or more configurations in accordance with example 900, 902, 904, or 906), and signaling of a precoder (such as one of the precoders described above) in accordance with the signaling of the UE capability, configuration, or support.

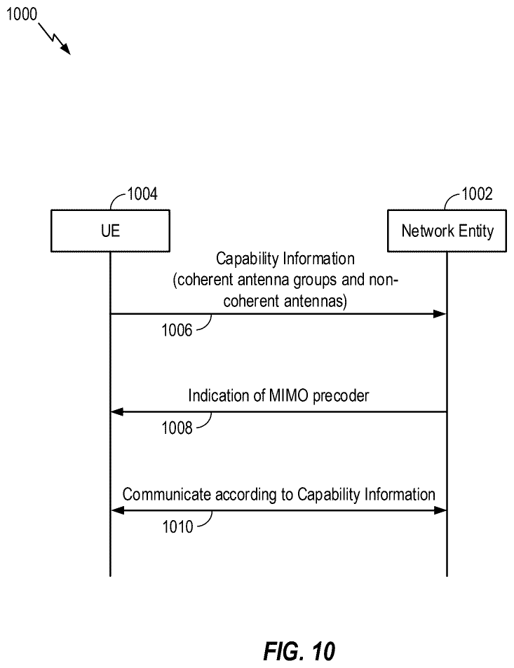

FIG. 10 is a diagram illustrating an example 1000 of signaling for indication of capability information and a precoder for a UE that implements mild coherence. Example 1000 includes a UE 1004 and a network entity 1002. In some aspects, the network entity 1002 may be an example of the BS 102 depicted and described with respect to FIG. 1, a first network entity 300 or second network entity 302 of FIG. 3, or a disaggregated base station depicted and described with respect to FIG. 2. Similarly, the UE 1004 may be an example of UE 104 or 304 depicted and described with respect to FIGS. 1 and 3. However, in other aspects, UE 1004 may be another type of wireless communications device and network entity 1002 may be another type of network entity or network node, such as those described herein.

As shown at 1006, the UE 1004 may transmit, and the network entity 1002 may receive, capability information. For example, the UE 1004 may send the capability information via a UE capability reporting (e.g., in response to a request from the network entity 1002 for the capability information).

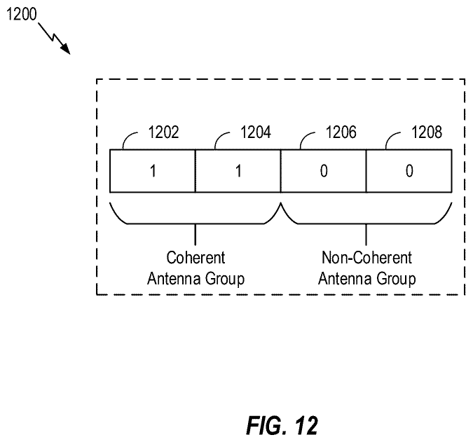

In example 1000, the UE 1004 is associated with a plurality of antenna groups. At least one antenna group of the plurality of antenna groups is coherent. Additionally, at least one antenna group of the plurality of antenna groups is non-coherent. The capability information may indicate a number of coherent antenna groups, a number of non-coherent antenna groups, specific antenna groups that are coherent or non-coherent, or the like. For example, the UE 1004 may be associated with Y antenna groups, where Y is an integer greater than 1. The capability information may indicate which antenna groups of the Y antenna groups are coherent. For example, the capability information may indicate Z coherent antenna groups of the Y antenna groups. In some aspects, the capability information includes a bitmap, as described with respect to FIG. 12. For example, for a UE 1004 supporting Z antenna groups, the capability information may include a Z-bit bitmap, where a first value of a bit of the bitmap indicates a corresponding antenna group is coherent and a second value of the bit of the bitmap indicates the corresponding antenna group is non-coherent. Thus, the UE 1004 may indicate specific antenna groups as coherent or non-coherent, facilitating selection of an appropriate precoder for the UE 1004.

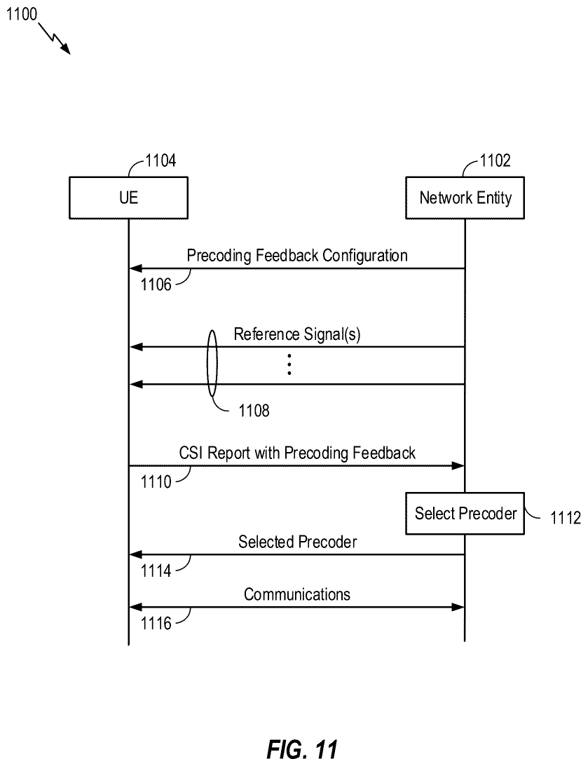

At 1008, the network entity 1002 transmits, and the UE 1004 receives, an indication of a precoder (illustrated as “MIMO precoder”). For example, the network entity 1002 may select the precoder in accordance with the capability information. To select the precoder in accordance with the capability information, the network entity 1002 may select a precoder that provides for a first number of coherent antenna groups and a second number of non-coherent antennas in accordance with a bitmap of the capability information. For example, if the capability information indicates one coherent antenna group with two antennas and two non-coherent antennas, the precoder selected by the network entity 1002 may have a first portion that supports communication by a two-antenna coherent antenna group, and a second portion that supports communication by two non-coherent antennas. Examples of such a precoder, for different numbers of layers are provided in connection with FIG. 9. In some aspects, the network entity 1002 may select the precoder based on a channel measurement, such as a measurement at the network entity 1002 (e.g., on a sounding reference signal transmitted by the UE 1004) or a reported measurement by the UE 1004 (e.g., on a CSI-RS transmitted by the network entity 1002), as described in connection with FIG. 11.

At 1010, the network entity 1002 and the UE 1004 communicate in accordance with the capability information, the precoder, or both. For example, the UE 1004 may transmit or receive a communication on the plurality of antennas (as indicated by the capability information) with a plurality of MIMO layers mapped according to the precoder. As another example, the network entity 1002 may transmit or receive a communication with a number of MIMO layers corresponding to the indicated precoder.

FIG. 11 depicts a process flow 1100 for communications in a system between a network entity 1102 and a UE 1104. In some aspects, the network entity 1102 may be an example of the BS 102 depicted and described with respect to FIGS. 1 and 3 or a disaggregated base station depicted and described with respect to FIG. 2. Similarly, the UE 1104 may be an example of UE 104 depicted and described with respect to FIGS. 1 and 3. However, in other aspects, UE 1104 may be another type of wireless communications device and network entity 1102 may be another type of network entity or network node, such as those described herein. The network entity 1102 and the UE 1104 may implement operations described with regard to the network entity 1002 and UE 1004 of FIG. 10. For example, prior to 1106, the UE 1104 may transmit capability signaling as described with regard to FIG. 10 at 1006.

At 1106, the UE 1104 optionally receives, from the network entity 1102, a precoding feedback configuration that indicates the port-level conditions for certain port selection codebooks, for example. In certain aspects, the UE 1104 may receive the precoding feedback configuration via Layer-1 signaling (e.g., downlink control information (DCI) or sidelink control information (SCI)), Layer-2 signaling (e.g., medium access control), Layer-3 signaling (e.g., radio resource control), and/or system information. As an example, the precoding feedback configuration may include a codebook configuration (e.g., the RRC information element CodebookConfig) for PMI feedback.

At 1108, the UE 1104 receives, from the network entity 1102, one or more (precoded) reference signals that correspond to different antenna ports (e.g., CSI-RS ports). The reference signal(s) may include, for example, an SSB, CSI-RS, DM-RS, etc.

At 1110, the UE 1104 sends, to the network entity 1102, a CSI report comprising precoding feedback. The precoding feedback may be provided in accordance with the configuration obtained at 1106.

At 1112, the network entity 1102 indicates, based on the CSI report, a precoder for the UE 1104. For example, the network entity 1102 may select the precoder based on an indication of an indicated precoder from the UE 1104, a reported measurement regarding the one or more reference signals, or the like. In some aspects (not shown in FIG. 11), the network entity 1102 measures an uplink reference signal from the UE 1104 and selects the precoder based on this reference signal.

At 1114, the network entity 1102 provides an indication of the selected precoder, as described with regard to 1008 of FIG. 10. At 1116, the network entity 1102 and the UE 1104 communicate in accordance with the selected precoder, as described with regard to 1010 of FIG. 10.

FIG. 12 is a diagram illustrating an example 1200 of a field of capability information that indicates a set of coherent antenna groups. The field includes a plurality of bit positions (in example 1200, 4 bit positions). Each bit position corresponds to an antenna group of a UE. For example, a UE or network entity may have prior knowledge of a number of antenna groups (and/or a number of antennas per antenna group) of the UE, such as based on prior signaling between the UE and the network entity.

As shown, a first bit position 1202 and a second bit position 1204 each include a first value (e.g., 1). The first value in the first bit position 1202 indicates that a first antenna group corresponding to the first bit position 1202 is coherent. The first value in the second bit position 1204 indicates that a first antenna group corresponding to the first bit position 1204 is coherent.

As shown, a third bit position 1206 and a fourth bit position 1208 each include a second value (e.g., 0). The second value in the third bit position 1206 indicates that a third antenna group corresponding to the third bit position 1206 is non-coherent. The second value in the fourth bit position 1208 indicates that a fourth antenna group corresponding to the fourth bit position 1208 is non-coherent.

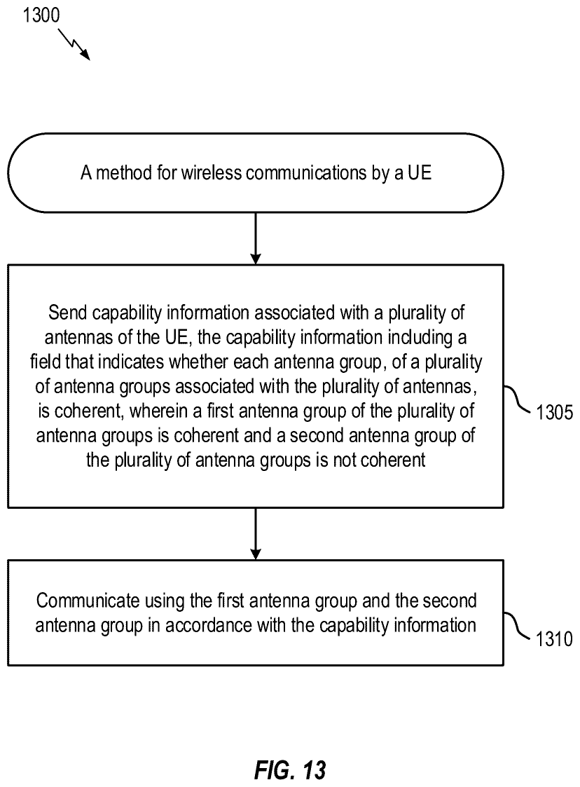

FIG. 13 shows a method 1300 for wireless communications by an apparatus, such as UE 104 of FIG. 1 or UE 304 of FIG. 3.

Method 1300 begins at block 1305 with sending capability information associated with a plurality of antennas of the UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent.

Method 1300 then proceeds to block 1310 with communicating using the first antenna group and the second antenna group in accordance with the capability information. For example, the apparatus may communicate using an indicated precoder (indicated by a network entity) using the first antenna group and the second antenna group.

In some aspects, the field indicates one coherent antenna group and one non-coherent antenna group.

In some aspects, the field indicates a plurality of coherent antenna groups and one non-coherent antenna group.

In some aspects, the field indicates a first number of coherent antenna groups and a second number of non-coherent antenna groups, wherein the first number is equal to the second number.

In some aspects, the field indicates one coherent antenna group and a plurality of non-coherent antenna groups.

In some aspects, the indicated precoder comprises a matrix with a first portion corresponding to the first antenna group and a second portion corresponding to the second group.

In some aspects, the first portion is diagonally concatenated with the second portion.

In some aspects, communicating in accordance with the indicated precoder comprises receiving a precoder from a network entity; and transmitting from the plurality of antennas of the UE according to the indicated precoder.

In some aspects, an uplink SRS for a first antenna in the first antenna group and a second antenna in the first antenna group has a first phase difference, a PUSCH for the first antenna in the first antenna group and the second antenna in the first antenna group has a second phase difference, and a difference between the first phase difference and the second phase difference is less than or equal to 40 degrees.

In some aspects, an uplink SRS for a first antenna in the first antenna group and a second antenna in the first antenna group has a first phase difference, a PUSCH for the first antenna in the first antenna group and the second antenna in the first antenna group has a second phase difference, and a difference between the first phase difference and the second phase difference is more than 40 degrees.

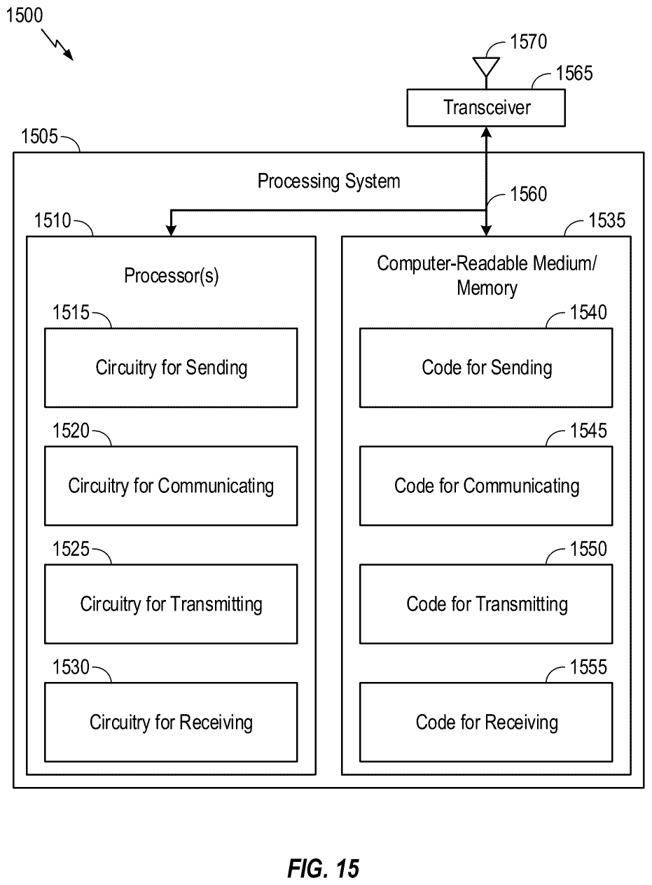

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

### Example Operations of a Network Entity

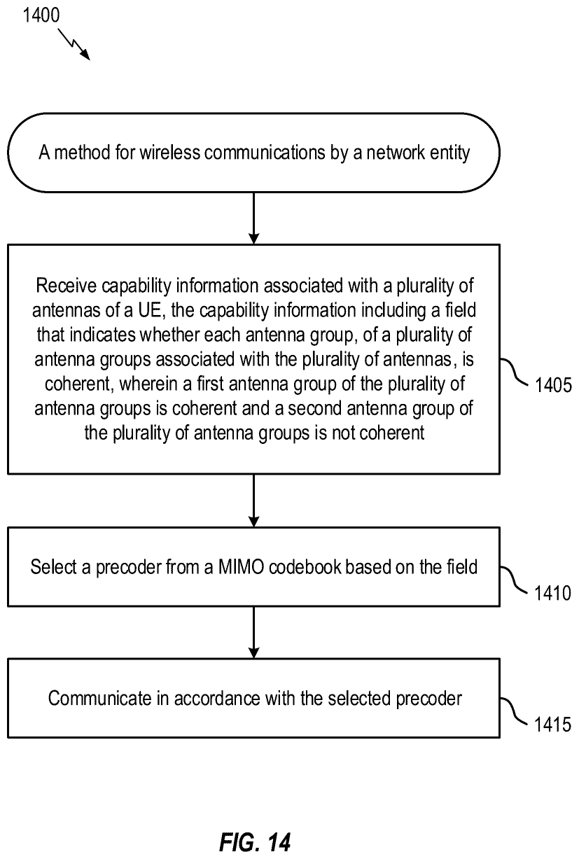

FIG. 14 shows a method 1400 for wireless communications by an apparatus, such as BS 102 of FIG. 1, a first network entity 300 or second network entity 302 of FIG. 3, or a disaggregated base station as discussed with respect to FIG. 2.

Method 1400 begins at block 1405 with receiving capability information associated with a plurality of antennas of a UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent.

Method 1400 then proceeds to block 1410 with selecting a precoder from a MIMO codebook based on the field.

Method 1400 then proceeds to block 1415 with communicating in accordance with the selected precoder.

In some aspects, the field indicates one coherent antenna group and one non-coherent antenna group.

In some aspects, the field indicates a plurality of coherent antenna groups and one non-coherent antenna group.

In some aspects, the field indicates a first number of coherent antenna groups and a second number of non-coherent antenna groups, wherein the first number is equal to the second number.

In some aspects, the field indicates one coherent antenna group and a plurality of non-coherent antenna groups.

In some aspects, the selected precoder comprises a matrix with a first portion corresponding to the first antenna group and a second portion corresponding to the second group.

In some aspects, the first portion is diagonally concatenated with the second portion.

In some aspects, block 1415 includes transmitting an indication of the selected precoder to the UE.

In some aspects, an uplink SRS for a first antenna in the first antenna group and a second antenna in the first antenna group has a first phase difference, a PUSCH for the first antenna in the first antenna group and the second antenna in the first antenna group has a second phase difference, and a difference between the first phase difference and the second phase difference is less than or equal to 40 degrees.

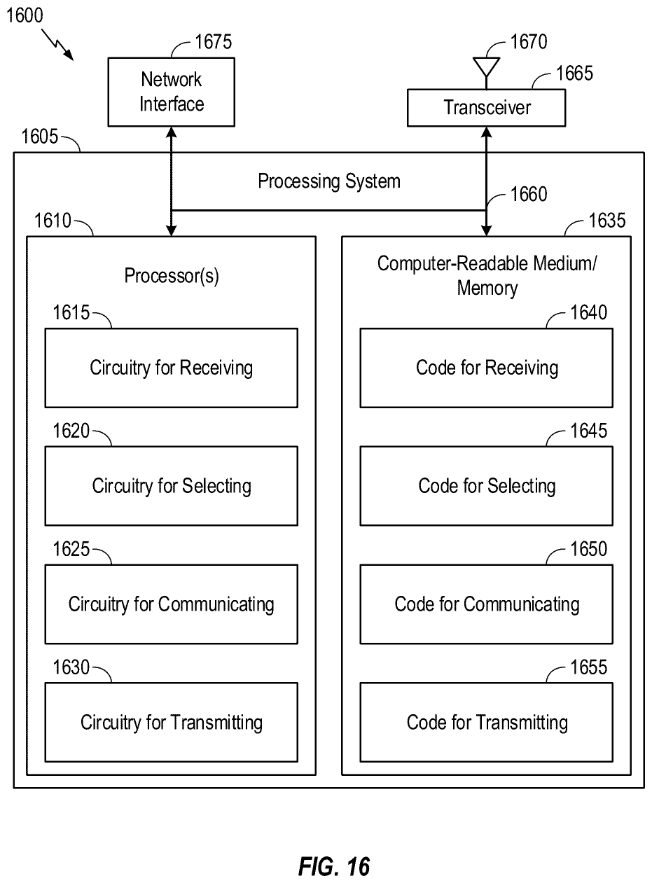

In some aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

### Example Communications Devices

FIG. 15 depicts aspects of an example communications device 1500 configured for wireless communications. In some aspects, communications device 1500 is a user equipment, such as UE 104 described above with respect to FIG. 1 or UE 304 described with respect to FIG. 3.

The communications device 1500 includes a processing system 1505 coupled to a transceiver 1565 (e.g., a transmitter and/or a receiver). The transceiver 1565 is configured to transmit and receive signals for the communications device 1500 via an antenna 1570, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1535. In various aspects, the one or more processors 1510 may be representative of the one or more processors 318 described with respect to FIG. 3. The one or more processors 1510 are coupled to a computer-readable medium/memory 1535 via a bus 1560. In some aspects, the computer-readable medium/memory 1535 may be representative of the one or more memories 320 described with respect to FIG. 3. The computer-readable medium/memory 1535 is a non-transitory computer-readable medium/memory. In certain aspects, the computer-readable medium/memory 1535 is configured to store instructions (e.g., computer-executable code), that when executed by the one or more processors 1510, cause the one or more processors 1510 to perform the method 1300 described with respect to FIG. 13, or any aspect related to it, including any operations described in relation to FIG. 13. Note that reference to a processor performing a function of communications device 1500 may include one or more processors performing that function of communications device 1500, such as in a distributed fashion.

In the depicted example, computer-readable medium/memory 1535 stores code (e.g., executable instructions), including code for sending 1540, code for communicating 1545, code for transmitting 1550, and code for receiving 1555. Processing of the code 1540-1555 may enable and cause the communications device 1500 to perform the method 1300 described with respect to FIG. 13, or any aspect related to it. For example, in some aspects, code for sending 1540 may include code for sending capability information associated with a plurality of antennas of the UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent. In some aspects, code for communicating 1545 may include code for communicating using the first antenna group and the second antenna group in accordance with the capability information.

The one or more processors 1510 include circuitry configured to implement (e.g., execute) the code stored in the computer-readable medium/memory 1535, including circuitry for sending 1515, circuitry for communicating 1520, circuitry for transmitting 1525, and circuitry for receiving 1530. Processing with circuitry 1515-1530 may enable and cause the communications device 1500 to perform the method 1300 described with respect to FIG. 13, or any aspect related to it. For example, in some aspects, circuitry for sending 1515 may include circuitry for sending capability information associated with a plurality of antennas of the UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent. In some aspects, circuitry for communicating 1520 may include circuitry for communicating using the first antenna group and the second antenna group in accordance with the capability information.

More generally, means for communicating, transmitting, sending or outputting for transmission may include the one or more transceivers 324, one or more antenna 322 and/or processing system 316 of the UE 304 illustrated in FIG. 3, transceiver 1565 and/or antenna 1570 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1565 and/or antenna 1570 of the communications device 1500 in FIG. 15, and/or one or more processors 1510 of the communications device 1500 in FIG. 15.

FIG. 16 depicts aspects of an example communications device configured for wireless communications. In some aspects, communications device 1600 is a network entity, such as BS 102 of FIG. 1, first network entity 300 or second network entity 302 of FIG. 3, or a disaggregated base station as discussed with respect to FIG. 2.

The communications device 1600 includes a processing system 1605 coupled to a transceiver 1665 (e.g., a transmitter and/or a receiver) and/or a network interface 1675. The transceiver 1665 is configured to transmit and receive signals for the communications device 1600 via an antenna 1670, such as the various signals as described herein. The network interface 1675 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610 and a computer-readable medium/memory 1635. In various aspects, one or more processors 1610 may be representative of the one or more processors 308, as described with respect to FIG. 3. The one or more processors 1610 are coupled to the computer-readable medium/memory 1635 via a bus 1660. In certain aspects, the computer-readable medium/memory 1635 is configured to store instructions (e.g., computer-executable code), including code 1640-1655, that when executed by the one or more processors 1610, cause the one or more processors 1610 to perform the method 1400 described with respect to FIG. 14, or any aspect related to it, including any operations described in relation to FIG. 14. The computer-readable medium/memory 1635 is a non-transitory computer-readable medium/memory. Note that reference to a processor of communications device 1600 performing a function may include one or more processors of communications device 1600 performing that function, such as in a distributed fashion.

In the depicted example, the computer-readable medium/memory 1635 stores code (e.g., executable instructions), including code for receiving 1640, code for selecting 1645, code for communicating 1650, and code for transmitting 1655. Processing of the code 1640-1655 may enable and cause the communications device 1600 to perform the method 1400 described with respect to FIG. 14, or any aspect related to it. For example, in some aspects, code for receiving 1640 may include code for receiving capability information associated with a plurality of antennas of a user equipment (UE), the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent. In some aspects, code for selecting 1645 may include code for selecting a precoder from a multiple-input, multiple-output (MIMO) codebook based on the field. In some aspects, code for communicating 1650 may include code for communicating in accordance with the selected precoder.

The one or more processors 1610 include circuitry configured to implement (e.g., execute) the code stored in the computer-readable medium/memory 1635, including circuitry for receiving 1615, circuitry for selecting 1620, circuitry for communicating 1625, and circuitry for transmitting 1630. Processing with circuitry 1615-1630 may enable and cause the communications device 1600 to perform the method 1400 described with respect to FIG. 14, or any aspect related to it. For example, in some aspects, circuitry for receiving 1615 may include circuitry for receiving capability information associated with a plurality of antennas of a user equipment (UE), the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent. In some aspects, circuitry for selecting 1620 may include circuitry for selecting a precoder from a multiple-input, multiple-output (MIMO) codebook based on the field. In some aspects, circuitry for communicating 1625 may include circuitry for communicating in accordance with the selected precoder.

Various components of the communications device 1600 may provide means for performing the method 1400 described with respect to FIG. 14, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1665, antenna 1670, and/or network interface 1675 of the communications device 1600 in FIG. 16, and/or one or more processors 1610 of the communications device 1600 in FIG. 16. Means for communicating, receiving or obtaining may include the one or more transceivers 312, one or more antennas 314, and/or processing system 306 of the first network entity 300 or the second network entity 302 illustrated in FIG. 3, transceiver 1665, antenna 1670, and/or network interface 1675 of the communications device 1600 in FIG. 16, and/or one or more processors 1610 of the communications device 1600 in FIG. 16.

### EXAMPLE CLAUSES

Implementation examples are described in the following numbered clauses:
Clause 1: A method for wireless communications by a UE comprising: sending capability information associated with a plurality of antennas of the UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent; and communicating using the first antenna group and the second antenna group using an indicated precoder in accordance with the capability information.
Clause 2: The method of Clause 1, wherein the field indicates one coherent antenna group and one non-coherent antenna group.
Clause 3: The method of any one of Clauses 1-2, wherein the field indicates a plurality of coherent antenna groups and one non-coherent antenna group.
Clause 4: The method of any one of Clauses 1-3, wherein the field indicates a first number of coherent antenna groups and a second number of non-coherent antenna groups, wherein the first number is equal to the second number.
Clause 5: The method of any one of Clauses 1-4, wherein the field indicates one coherent antenna group and a plurality of non-coherent antenna groups.
Clause 6: The method of any one of Clauses 1-5, wherein the indicated precoder comprises a matrix with a first portion corresponding to the first antenna group and a second portion corresponding to the second antenna group.
Clause 7: The method of Clause 6, wherein the first portion is diagonally concatenated with the second portion.
Clause 8: The method of any one of Clauses 1-7, wherein communicating in accordance with the indicated precoder comprises receiving a precoder from a network entity; and transmitting from the plurality of antennas of the UE according to the indicated precoder.
Clause 9: The method of any one of Clauses 1-8, wherein an uplink SRS for a first antenna in the first antenna group and a second antenna in the first antenna group has a first phase difference, a PUSCH for the first antenna in the first antenna group and the second antenna in the first antenna group has a second phase difference, and a difference between the first phase difference and the second phase difference is less than or equal to 40 degrees.
Clause 10: The method of any one of Clauses 1-9, wherein an uplink SRS for a first antenna in the first antenna group and a second antenna in the first antenna group has a first phase difference, a PUSCH for the first antenna in the first antenna group and the second antenna in the first antenna group has a second phase difference, and a difference between the first phase difference and the second phase difference is more than 40 degrees.
Clause 11: A method for wireless communications by a network entity comprising: receiving capability information associated with a plurality of antennas of a UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent; selecting a precoder from a MIMO codebook based on the field; and communicating in accordance with the selected precoder.
Clause 12: The method of Clause 11, wherein the field indicates one coherent antenna group and one non-coherent antenna group.
Clause 13: The method of any one of Clauses 11-12, wherein the field indicates a plurality of coherent antenna groups and one non-coherent antenna group.
Clause 14: The method of any one of Clauses 11-13, wherein the field indicates a first number of coherent antenna groups and a second number of non-coherent antenna groups, wherein the first number is equal to the second number.
Clause 15: The method of any one of Clauses 11-14, wherein the field indicates one coherent antenna group and a plurality of non-coherent antenna groups.
Clause 16: The method of any one of Clauses 11-15, wherein the selected precoder comprises a matrix with a first portion corresponding to the first antenna group and a second portion corresponding to the second group.
Clause 17: The method of Clause 16, wherein the first portion is diagonally concatenated with the second portion.
Clause 18: The method of any one of Clauses 11-17, wherein communicating in accordance with the selected precoder comprises transmitting an indication of the selected precoder to the UE.
Clause 19: The method of any one of Clauses 11-18, wherein an uplink SRS for a first antenna in the first antenna group and a second antenna in the first antenna group has a first phase difference, a PUSCH for the first antenna in the first antenna group and the second antenna in the first antenna group has a second phase difference, and a difference between the first phase difference and the second phase difference is less than or equal to 40 degrees.
Clause 20: One or more apparatuses, comprising: one or more memories comprising executable instructions; and one or more processors configured to execute the executable instructions and cause the one or more apparatuses to perform a method in accordance with any one of Clauses 1-20.
Clause 21: One or more apparatuses configured for wireless communications, comprising: one or more memories; and one or more processors, coupled to the one or more memories, configured to cause the one or more apparatuses to perform a method in accordance with any one of Clauses 1-20.
Clause 22: One or more apparatuses configured for wireless communications, comprising: one or more memories; and one or more processors, coupled to the one or more memories, configured to perform a method in accordance with any one of Clauses 1-20.
Clause 23: One or more apparatuses, comprising means for performing a method in accordance with any one of Clauses 1-20.
Clause 24: One or more non-transitory computer-readable media comprising executable instructions that, when executed by one or more processors of one or more apparatuses, cause the one or more apparatuses to perform a method in accordance with any one of Clauses 1-20.
Clause 25: One or more computer program products embodied on one or more computer-readable storage media comprising code for performing a method in accordance with any one of Clauses 1-20.
Clause 26: One or more apparatuses configured for wireless communications, comprising: a processing system that includes one or more processors and one or more memories coupled with the one or more processors, the processing system configured to cause the one or more apparatuses to perform a method in accordance with any one of Clauses 1-20.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
send capability information associated with a plurality of antennas of the UE, the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent; and
communicate using the first antenna group and the second antenna group using an indicated precoder in accordance with the capability information.

2. The apparatus of claim 1, wherein the field indicates one coherent antenna group and one non-coherent antenna group.

3. The apparatus of claim 1, wherein the field indicates a plurality of coherent antenna groups and one non-coherent antenna group.

4. The apparatus of claim 1, wherein the field indicates a first number of coherent antenna groups and a second number of non-coherent antenna groups, wherein the first number is equal to the second number.

5. The apparatus of claim 1, wherein the field indicates one coherent antenna group and a plurality of non-coherent antenna groups.

6. The apparatus of claim 1, wherein the indicated precoder comprises a matrix with a first portion corresponding to the first antenna group and a second portion corresponding to the second group.

7. The apparatus of claim 6, wherein the first portion is diagonally concatenated with the second portion.

8. The apparatus of claim 1, wherein to cause the UE to communicate in accordance with the indicated precoder, the processing system is configured to cause the UE to receive a precoder from a network entity; and
transmit from the plurality of antennas of the UE according to the indicated precoder.

9. The apparatus of claim 1, wherein an uplink sounding reference signal (SRS) for a first antenna in the first antenna group and a second antenna in the first antenna group has a first phase difference, a physical uplink shared channel (PUSCH) for the first antenna in the first antenna group and the second antenna in the first antenna group has a second phase difference, and a difference between the first phase difference and the second phase difference is less than or equal to 40 degrees.

10. The apparatus of claim 1, wherein an uplink sounding reference signal (SRS) for a first antenna in the first antenna group and a second antenna in the first antenna group has a first phase difference, a physical uplink shared channel (PUSCH) for the first antenna in the first antenna group and the second antenna in the first antenna group has a second phase difference, and a difference between the first phase difference and the second phase difference is more than 40 degrees.

11. An apparatus for wireless communications, comprising a processing system that includes one or more processors and one or more memories coupled with the one or more processors, the processing system configured to cause a network entity to:
receive capability information associated with a plurality of antennas of a user equipment (UE), the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent;
select a precoder from a multiple-input, multiple-output (MIMO) codebook based on the field; and
communicate in accordance with the selected precoder.

12. The apparatus of claim 11, wherein the field indicates one coherent antenna group and one non-coherent antenna group.

13. The apparatus of claim 11, wherein the field indicates a plurality of coherent antenna groups and one non-coherent antenna group.

14. The apparatus of claim 11, wherein the field indicates a first number of coherent antenna groups and a second number of non-coherent antenna groups, wherein the first number is equal to the second number.

15. The apparatus of claim 11, wherein the field indicates one coherent antenna group and a plurality of non-coherent antenna groups.

16. The apparatus of claim 11, wherein the selected precoder comprises a matrix with a first portion corresponding to the first antenna group and a second portion corresponding to the second antenna group.

17. The apparatus of claim 16, wherein the first portion is diagonally concatenated with the second portion.

18. The apparatus of claim 11, wherein to cause the network entity to communicate in accordance with the selected precoder, the processing system is configured to cause the network entity to transmit an indication of the selected precoder to the UE.

19. The apparatus of claim 11, wherein an uplink sounding reference signal (SRS) for a first antenna in the first antenna group and a second antenna in the first antenna group has a first phase difference, a physical uplink shared channel (PUSCH) for the first antenna in the first antenna group and the second antenna in the first antenna group has a second phase difference, and a difference between the first phase difference and the second phase difference is less than or equal to 40 degrees.

20. A method for wireless communications by a network entity, comprising:
receiving capability information associated with a plurality of antennas of a user equipment (UE), the capability information including a field that indicates whether each antenna group, of a plurality of antenna groups associated with the plurality of antennas, is coherent, wherein a first antenna group of the plurality of antenna groups is coherent and a second antenna group of the plurality of antenna groups is not coherent;
selecting a precoder from a multiple-input, multiple-output (MIMO) codebook based on the field; and
communicating in accordance with the selected precoder.
